(19) United States
(12) Patent Application Publication
(10) Pub. No.: US 2022/0009825 A1
(43) Pub. Date: Jan. 13, 2022

(54) METHOD FOR MANUFACTURING AN ELECTROCHROMIC GLAZING

(71) Applicant: SAINT-GOBAIN GLASS FRANCE, COURBEVOIE (FR)

(72) Inventor: Pascal REUTLER, PARIS (FR)

(21) Appl. No.: 17/297,819

(22) PCT Filed: Nov. 27, 2019
(86) PCT No.: PCT/FR2019/052821

§ 371 Date: May 27, 2021

(30) Foreign Application Priority Data
Nov. 28, 2018 (FR) 1872014

(51) Int. Cl. C03C 17/34; G02F 1/155

(52) U.S. Cl. CPC C03C 17/3411; G02F 2001/1555; C03C 2218/32; G02F 1/155

(57) ABSTRACT

A process for manufacturing an electrochromic glazing, including an electrochromic stack including a first transparent conductive layer, a layer of an electrochromic material, a layer of an ionically conductive electrolyte, a counter electrode layer, a second transparent conductive layer, the process including providing a first and a second glass panel; depositing a first and a second transparent conductive layer on respectively the first and second glass panel; depositing a layer of a material on the first transparent conductive layer and a counter electrode layer on the second transparent conductive layer; depositing the layer of an ionically conductive electrolyte on one or other of the layers of an electro0chromic material or counter electrode layer; assembling the two glass panels to form a laminated glazing. A heat treatment is performed to heat treat a transparent conductive layer of a glass panel via a rapid heating device before assembling the glass panels.

The present invention relates to the field of electrochromic glazings and to the process for the manufacture thereof.

### PRIOR ART

Electrochromic devices and in particular electrochromic glazings comprise, as is known, an electrochromic stack comprising a succession of five layers essential to the operation of the device, i.e. to the reversible color change following the application of a suitable power supply. These five functional layers are the following:
a first transparent electrically conductive layer,
a layer of an electrochromic material, capable of reversibly and simultaneously inserting ions, the oxidation states of which, corresponding to the inserted and ejected states, have a distinct color when they are subjected to a suitable power supply; one of these states having a higher light transmission than the other,
a layer of an ionically conductive and electronically insulating electrolyte,
a counter electrode layer, capable of reversibly inserting ions of the same charge as those that the electrochromic material can insert, and
a second transparent electrically conductive layer,
   it being possible for one or other of the transparent electrically conductive layers to be in contact with the transparent substrate.

In the most common electrochromic systems, these five layers all consist of inorganic solid materials, most often metal oxides, and are deposited by magnetron sputtering on a glass substrate. They are commonly referred to as “all-solid-state” electrochromic systems.

The process for the magnetron sputtering manufacture of such a mineral electrochromic system with at least five layers includes one or more heat treatment (annealing) steps during or after the steps of depositing the layers by magnetron sputtering. Certain materials, especially the metal oxides forming the two outermost transparent conductive layers of the stack, are deposited by magnetron sputtering. In order to have a satisfactory crystallinity and conductivity, these conductive layers may be deposited hot, or be deposited cold and undergo, after this cold deposition, a heat treatment. The performance and optical properties of the final product are highly dependent on these heat treatment steps.

Another known process consists in providing two glass panels and in depositing, on each of them, a transparent conductive (TC) layer.

Subsequently, according to this other process, the electrochromic (EC) layer and the counter electrode (CE) layer are each deposited on one transparent conductive layer. Next, the layer of an ionically conductive and electronically insulating electrolyte is arranged on the electrochromic (EC) layer or on the counter electrode (CE) layer. Everything is then assembled in order to form the glazing. This assembling step further comprises the creation of connection means for conveying the current to the transparent conductive layers.

If the transparent conductive layers are deposited cold, the roughness of the layers is low, which is an advantage, but their electrical conductivity is also low so that the performance properties are worse. However, if the layers are subjected to an annealing-type heat treatment, this being characterized by a slow increase in temperature and by a long treatment time, usually around one hour in a furnace at 400° C., the electrical conductivity of the layers increases so as to improve the performance properties of the glazing. But this treatment involves an increase in the size of the crystals and therefore also in the roughness. This increase in the size of the crystals is also observed if the transparent conductive layers are deposited hot (deposition at a temperature above 150° C.).

However, as each transparent conductive (TCO) layer is heat-treated independently, the roughnesses of the transparent conductive layers are different. Thus, during the assembling of the glass panels, the assembly formed of the transparent conductive layer and of the electrochromic (EC) layer on the one hand and the assembly formed of the transparent conductive layer and of the counter electrode (CE) layer on the other hand, with different roughnesses, exert a pressure/stress on the layer of the ionically conductive and electronically insulating electrolyte at the risk of deforming it. As this roughness is uneven, locally there may be an uneven thickness, that is to say that, locally, the layer of an ionically conductive electrolyte is thinner, more compressed, thus making the performance properties of the electrochromic glazing unequal and inhomogeneous.

### SUMMARY OF THE INVENTION

The present invention therefore proposes to solve these drawbacks by providing a process for producing an electrochromic glazing in which the electrolyte layer has smaller local thickness variations.

For this purpose, the invention relates to a process for manufacturing an electrochromic glazing, said glazing comprising an electrochromic stack comprising:
a first transparent conductive layer,
a layer of a cathodically-colored mineral electrochromic material, referred to as electrochromic electrode,
a layer of an ionically conductive and electronically insulating electrolyte,
a counter electrode layer,
a second transparent conductive layer,
   said process comprising the following steps:
providing a first glass panel and a second glass panel;
depositing a first transparent conductive layer on the first glass panel and a second transparent conductive layer on the second glass panel;
depositing a layer of an electrochromic material on the first transparent conductive layer and a counter electrode layer on the second transparent conductive layer;
depositing a layer of an ionically conductive electrolyte on one or other of the layers of an electrochromic material or counter electrode layer;
assembling the two glass panels to form a laminated glazing,
   characterized in that it comprises, in addition, at least one heat treatment step that consists in heat treating at least one glass panel provided with at least one transparent conductive layer via a rapid heat treatment device before assembling the glass panels.

According to one example, said heat treatment step is used to treat the transparent conductive layer of each glass panel.

According to one example, a heat treatment step is, in addition, used to treat the layer of an electrochromic material and/or the counter electrode layer.

According to one example, said step of heat treatment of said at least one transparent conductive layer is carried out after the deposition of the first transparent conductive layer on the first glass panel and/or of the second transparent conductive layer on the second glass panel.

According to one example, said heat treatment step is carried out in order to simultaneously treat the layer of an electrochromic material and the first transparent conductive layer and/or in order to simultaneously treat the counter electrode layer and the second transparent conductive layer.

According to one example, the heat treatment device is placed facing the layer to be treated and is arranged to bring the layer to be treated to a temperature at least equal to 300° C.

According to one example, the heat treatment device is arranged to heat treat the layer to be treated for a brief duration, preferably of less than 100 milliseconds.

According to one example, the heat treatment device is a laser device emitting radiation that has a wavelength of between 300 and 2000 nm.

According to one example, the heat treatment device comprises at least one intense pulsed light lamp emitting radiation that has an emission spectrum preferably comprising several lines, in particular at wavelength ranging from 160 to 1000 nm, each light pulse having a duration preferably within a range extending from 0.05 to 20 milliseconds.

### DESCRIPTION OF THE FIGURES

Other distinctive features and advantages will become clearly apparent from the nonlimiting description that is given thereof below, by way of indication, with reference to the appended drawings, in which:

FIG. 1 is a schematic representation of the electrochromic glazing according to the invention.

### DETAILED DESCRIPTION OF THE INVENTION

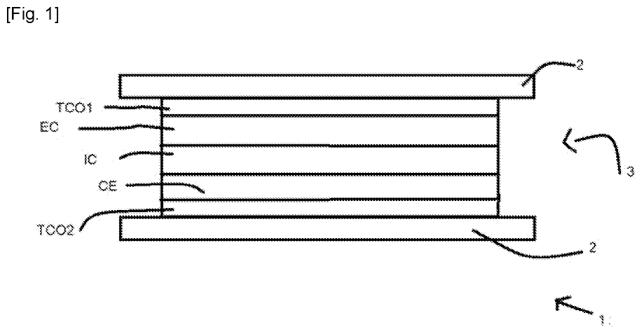

An electrochromic glazing 1 is represented in FIG. 1. Such an electrochromic glazing comprises two glass panels 2 held together by a framework or frame. Between these two glass panels, a complete electrochromic stack 3 is arranged. This stack comprises:
a first transparent electrically conductive TCO1 layer,
a layer of an electrochromic material EC, capable of reversibly and simultaneously inserting ions, the oxidation states of which, corresponding to the inserted and ejected states, have a distinct color when they are subjected to a suitable power supply; one of these states having a higher light transmission than the other,
a layer of an ionically conductive and electronically insulating electrolyte CI,
a counter electrode CE layer, capable of reversibly inserting ions of the same charge as those that the electrochromic material can insert, and
a second transparent electrically conductive TCO2 layer.

The five (TCO1/EC/CI/CE/TCO2) layers listed above are the only functional layers essential to the correct operation of the electrochromic glazing.

The electrochromic stack 3 may comprise other useful layers, which are not however essential to obtaining electrochromic behavior. It may for example comprise, between the glass substrate and the adjacent TCO layer, a barrier layer, known for preventing for example the migration of sodium ions. The stack may also comprise one or more antireflection or color-adapting layers comprising for example an alternation of transparent layers with high and low refractive index.

All of the mineral layers of the stack are preferably deposited by reactive or non-reactive magnetron sputtering, generally in the same vacuum apparatus.

The materials capable of serving as transparent conductive oxides for the two transparent conductive TCO layers are known. Mention may be made, by way of example, of indium oxide, mixed indium tin oxide, tin oxide, doped tin oxide, zinc oxide, doped zinc oxide, ruthenium oxide, doped ruthenium oxide and aluminum- and/or gallium-doped zinc oxide. Mixed indium tin oxide (ITO) or aluminum- and/or gallium-doped zinc oxide will preferably be used. The thickness of each of the TCO layers is preferably between 10 and 1000 nm, preferably between 50 and 800 nm.

For a mixed indium tin oxide (ITO) layer, this will be made, for example, with a thickness of 250 nm, will be in particular deposited hot, and will have a sheet resistance of the order of 10 Ohms.

As a variant, it may also be a fluorine- or antimony-doped tin oxide layer, or a multilayer.

Each transparent conductive oxide layer is deposited on one of the glass panels.

Of course, the two transparent conductive oxide layers must be connected to respective current feed connectors. These connectors, for example busbars and wires, are respectively bought into contact with the transparent conductive oxide TCO1 layer and the transparent conductive oxide TCO2 layer in order to supply the suitable power supply.

The electrochromic material EC is preferably based on tungsten oxide (cathodic electrochromic material) or on iridium oxide (anodic electrochromic material). These materials may insert cations, in particular protons or lithium ions.

The counter electrode CE preferably consists of a layer that is a neutral in color or, at least, transparent or barely colored when the electrochromic layer is in the colored state. The counter electrode is preferably based on an oxide of an element chosen from tungsten, nickel, iridium, chromium, iron, cobalt, rhodium, or based on a mixed oxide of at least two of these elements, in particular mixed tungsten nickel oxide. If the electrochromic material is tungsten oxide, therefore a cathodic electrochromic material, the colored state of which corresponds to the most reduced state, an anodic electrochromic material based on nickel oxide or iridium oxide may, for example, be used for the counter electrode. It may in particular be a mixed tungsten vanadium oxide layer or a mixed tungsten nickel oxide layer. If the electrochromic material is iridium oxide, a cathodic electrochromic material, for example based on tungsten oxide, may act as counter electrode. It is also possible to use a material that is optically neutral in the oxidation states in question, such as, for example, cerium oxide or organic materials such as electronically-conductive polymers (polyaniline) or Prussian blue.

The thickness of the counter electrode is generally between 50 nm and 600 nm, in particular between 150 nm and 250 nm.

According to one embodiment, the electrolyte CI is in the form of a polymer or a gel, in particular a proton-conducting polymer, for example such as those described in European patents EP 0 253 713 and EP 0 670 346, or a lithium ion-conducting polymer, for example such as those described in patents EP 0 382 623, EP 0 518 754 or EP 0 532 408. These are then referred to as mixed electrochromic systems. According to another embodiment, the electrolyte CI consists of a mineral layer forming an ion conductor which is electrically insulated. These electrochromic systems are then denoted as being “all-solid-state”. Reference may in particular be made to European patents EP 0 867 752 and EP 0 831 360. The thickness of the electrolyte layer may be between 1 nm and 1 mm. Preferably, the thickness will be between 1 and 300 nm and more preferentially still between 1 and 50 nm.

An electrochromic glazing comprising an electrochromic stack is manufactured according to the manufacturing process, said stack comprising:
a first transparent electrically conductive TCO1 layer,
a layer of an electrochromic material EC, capable of reversibly and simultaneously inserting ions, the oxidation states of which, corresponding to the inserted and ejected states, have a distinct color when they are subjected to a suitable power supply; one of these states having a higher light transmission than the other,
a layer of an ionically conductive and electronically insulating electrolyte CI,
a counter electrode CE layer, capable of reversibly inserting ions of the same charge as those that the electrochromic material can insert, and
a second transparent electrically conductive TCO2 layer.

A first step of the manufacturing process consists in providing two glass substrates or panels 2. The glass panels 2 used are typically made of float glass that is optionally cut, polished and washed.

A second step consists in depositing, on each glass panel 2, at least one layer of a transparent conductive oxide TCO1/TCO2. A first glass panel 2, on which a first layer of a transparent conductive oxide TCO1 is deposited, and a second glass panel 2, on which a second layer of a transparent conductive oxide TCO2 is deposited, are then obtained. It will be understood that the term “to deposit” does not mean that the layer is deposited directly on the glass panel but that it may be deposited on an layer that already exists.

In a third step, the layer of an electrochromic material EC is deposited on the first glass panel 2 and the layer referred to as the counter electrode layer CE is deposited on the second glass panel 2.

A fourth step consists in depositing at least the ionically conductive electrolyte CI layer.

This ionically conductive electrolyte CI layer is deposited on the layer of an electrochromic material EC or on the layer referred to as the counter electrode CE layer.

This ionically conductive electrolyte CI layer may be deposited in various ways.

For example, this layer may be deposited by reactive or non-reactive magnetron sputtering, generally in the same vacuum apparatus.

In another example, this ionically conductive electrolyte layer may be deposited in the form of a gel. Such a gel process consists in depositing the ionically conductive electrolyte CI layer in liquid form on the desired surface. A heat treatment is then carried out in order to obtain the desired ionically conductive electrolyte CI layer.

Cleverly, according to the invention, a heat treatment step is performed. This heat treatment is carried out at least on one of the transparent electrically conductive TCO1, TCO2 layers, preferably on the transparent conductive oxide layer of each glass panel 2. This heat treatment step is performed between the second step and the third step of the process for manufacturing the electrochromic glazing. In this case, the heat treatment acts only on the transparent electrically-conductive TCO1, TCO2 layers. In the case of a heat treatment of the transparent electrically-conductive layer of each glass panel 2, each panel may be treated by a different heat treatment device or by the same treatment device.

In a variant, a so-called additional heat treatment is also applied to the layer of an electrochromic material EC and/or to the layer referred to as the counter electrode CE layer. In that case, a heat treatment step also takes place between the third step and the fourth step of the process for manufacturing the electrochromic glazing. It is therefore understood that the heat treatment takes place between the second step and the third step for the treatment of at least one transparent electrically-conductive TCO1, TCO2 layer of a glass panel and that another heat treatment takes place between the third step and the fourth step for the treatment of the layer of an electrochromic material EC and/or of the layer referred to as the counter electrode CE layer.

In another variant, a single heat treatment step is provided. This heat treatment step is performed between the third step and the fourth step of the process for manufacturing the electrochromic glazing and is arranged to heat treat the layer of an electrochromic material EC and the first transparent electrically-conductive TCO1 layer or the counter electrode CE layer and the second transparent electrically-conductive TCO2 layer. It is therefore understood that the TCO1/EC-TCO2/CE layers of a same glass panel 2 are heat-treated simultaneously. Provision could also be made for the two glass panels 2 to be treated at the same time.

This heat treatment is performed by a rapid heat treatment device, it being possible for the latter to use various technologies. A rapid heat treatment is understood to mean a heat treatment for which, locally, the layer to be treated is subjected to a sudden/abrupt increase in temperature followed by a sudden/abrupt decrease in temperature.

In the case of laser technology, laser sources are used and are typically laser diodes or fiber-delivered lasers, in particular fiber lasers, diode lasers or else disk lasers. Laser diodes enable high power densities, relative to the electrical supply power, to be achieved economically and with a small space requirement. The space requirement of fiber-delivered lasers is even smaller, and the linear power obtained may be even higher. The expression “fiber-delivered lasers” is understood to mean lasers in which the place where the laser light is generated is spatially removed from the place to which it is delivered, the laser light being delivered by means of at least one optical fiber. In the case of a disk laser, the laser light is generated in a resonant cavity in which the emitting medium, which is in the form of a disk, for example a thin (about 0.1 mm thick) disk made of Yb:YAG, is found. The light thus generated is coupled to at least one optical fiber directed toward the place of treatment. Fiber or disk lasers are preferably optically pumped using laser diodes.

The radiation resulting from the laser sources is preferably continuous.

The wavelength of the laser radiation is within a range extending from 500 to 2000 nm, preferably from 700 to 1100 nm and in particular from 800 to 1000 nm. Power laser diodes emitting at one or more wavelengths chosen from 808 nm, 880 nm, 915 nm, 940 nm or 980 nm have proved to be particularly suitable. In the case of a disk laser, the wavelength is for example 1030 nm (emission wavelength for a Yb:YAG laser). For a fiber laser, the wavelength is typically 1070 nm.

In the case of lasers not delivered by fiber, the shaping and redirecting optics preferably comprise lenses and mirrors and are used as means for positioning, homogenizing and focusing the radiation.

The aim of the positioning means is, if need be, to arrange the radiation emitted by the laser sources in a line. Said means preferably comprise mirrors. The aim of the homogenizing means is to superpose the spatial profiles of the laser sources in order to obtain a homogeneous linear power over the entire length of the line. The homogenizing means preferably comprise lenses allowing the incident beams to be separated into secondary beams and said secondary beams to be recombined into a homogeneous line. The means for focusing the radiation allow the radiation to be focused on the transparent conductive oxide layer(s) to be treated, in the form of a line of the desired length and width. The focusing means preferably comprise a focusing mirror or a convergent lens.

In the case of fiber-delivered lasers, the shaping optics are preferably grouped together in the form of an optical head positioned at the output of the or each optical fiber.

The shaping optics of said optical heads preferably comprise lenses, mirrors and prisms and are used as means for converting, homogenizing and focusing the radiation.

The converting means comprise mirrors and/or prisms and serve to convert the circular beam, output from the optical fiber, into a noncircular, anisotropic, line-shaped beam. To do this, the converting means increase the quality of the beam along one of its axes (fast axis, or axis of the width l of the laser line) and decrease the quality of the beam along the other (slow axis, or axis of the length L of the laser line).

The homogenizing means superpose the spatial profiles of the laser sources in order to obtain a homogeneous linear power over the entire length of the line. The homogenizing means preferably comprise lenses allowing the incident beams to be separated into secondary beams and said secondary beams to be recombined into a homogeneous line.

Lastly, the means for focusing the radiation allow the radiation to be focused in the working plane, i.e. in the plane of the layer to be treated, in the form of a line of the desired length and width. The focusing means preferably comprise a focusing mirror or a convergent lens.

When a single laser line is used, the length of the line is advantageously equal to the width of the substrate. This length is typically at least 1 m, in particular at least 2 m and particularly at least 3 m. A plurality of optionally separate lines may also be used, provided these lines are arranged to treat the entire width of the substrate. In this case, the length of each laser line is preferably at least 10 cm or 20 cm, in particular within a range extending from 30 to 100 cm, in particular from 30 to 75 cm and even from 30 to 60 cm.

The “length” of the line is understood to be the largest dimension of the line, measured at the surface of the transparent conductive oxide layer, and the “width” is understood to be the dimension along a second direction perpendicular to the first. As is conventional in the field of lasers, the width (w) of the line corresponds to the distance, along this second direction, between the axis of the beam where the intensity of the radiation is maximum and the point where the intensity of the radiation is equal to 1/e² times the maximum intensity. If the longitudinal axis of the laser line is denoted x, a width distribution denoted w(x) may be defined along this axis.

The mean width of the or each laser line is preferably at least 35 micrometers and in particular within a range extending from 40 to 100 micrometers or from 40 to 70 micrometers. Throughout the present text, the term “mean” is understood to mean the arithmetic mean. Over the entire length of the line, the width distribution is narrow in order to limit as much as possible any treatment heterogeneity. Thus, the difference between the largest width and the smallest width is preferably at most 10% of the value of the mean width. This value is preferably at most 5% and even 3%.

The laser modules are preferably mounted on a rigid structure, called a “bridge”, based on metal elements that are typically made of aluminum. The structure preferably does not comprise a marble sheet. The bridge is preferably positioned parallel to the conveying means that convey the substrate so that the focal plane of the laser line remains parallel to the surface of the substrate to be treated. Preferably, the bridge comprises at least four feet, the height of which may be individually adjusted in order to ensure parallel positioning under any circumstances. The adjustment may be carried out by motors located in each foot, either manually, or automatically, in connection with a distance sensor. The height of the bridge may be modified (manually or automatically) to take into account the thickness of the substrate to be treated, and to thus ensure that the plane of the substrate coincides with the focal plane of the laser line.

The linear power of the laser line is preferably at least 50 W/cm, advantageously 100 W/cm, in particular 200 W/cm, or 300 W/cm and even 400 W/cm. It is even advantageously at least 600 W/cm, in particular 800 W/cm or 1000 W/cm. The linear power is measured at the place where the or each laser line is focused on the transparent conductive oxide layer. It may be measured by placing a power detector along the line, for example a calorimetric power meter, in particular such as the Beam Finder (S/N 2000716) power meter from the company Coherent Inc. The power is advantageously distributed homogeneously over the entire length of the or each line. Preferably, the difference between the highest power and the lowest power is less than 10% of the mean power.

According to a preferred embodiment, the radiation originates from at least one intense pulsed light (IPL) lamp, referred to hereinafter as a flash lamp.

Such flash lamps are generally in the form of sealed glass or quartz tubes filled with a noble gas, and provided with electrodes at their ends. Under the effect of a short electrical pulse, obtained by discharging a capacitor, the gas ionizes and produces a particularly intense incoherent light. The emission spectrum generally comprises at least two emission lines; it is preferably a continuous spectrum having an emission maximum in the near ultraviolet.

The lamp is preferably a xenon lamp. It may also be an argon lamp, a helium lamp or a krypton lamp. The emission spectrum preferably comprises a plurality of lines, in particular at wavelengths ranging from 160 to 1000 nm.

The length of each light pulse is preferably within a range extending from 0.05 to 20 milliseconds, in particular from 0.1 to 5 milliseconds. The repetition rate is preferably within a range extending from 0.1 to 5 Hz, in particular from 0.2 to 2 Hz.

The radiation may originate from a plurality of lamps placed side-by-side, for example 5 to 20 lamps, or else 8 to 15 lamps, so as to simultaneously treat a wider region. All the lamps may in this case emit flashes simultaneously.

The or each lamp is preferably placed transversely to the longest sides of the substrate. The or each lamp is preferably at least 1 m in length, in particular 2 m and even 3 m in length so as to allow large substrates to be treated.

The capacitor is typically charged at a voltage from 500 V to 500 kV. The current density is preferably at least 4000 A/cm². The total energy density emitted by the flash lamps, normalized with respect to the surface area of the transparent conductive oxide layer, is preferably between 1 and 100 J/cm², in particular between 1 and 30 J/cm² or between 5 and 20 J/cm².

The high energy densities and powers enable the layer to be treated to be heated very rapidly to high temperatures.

During the step of annealing the layer to be treated of the process according to the invention each point of the layer to be treated is preferably brought to a temperature of at least 300° C., in particular 350° C., or 400° C., and even 500° C. or 600° C. The maximum temperature is normally attained at the moment when the point of the layer to be treated under consideration passes under the radiation device, for example under the laser line or under the flash lamp. At a given instant, only the points of the surface of the layer located under the radiation device (for example under the laser line) and in the immediate vicinity thereof (for example less than one millimeter away) are normally at a temperature of at least 300° C. For distances to the laser line (measured along the run direction) of greater than 2 mm, in particular 5 mm, including downstream of the laser line, the temperature of the electrochromic stack is normally at most 50° C., and even 40° C. or 30° C.

Each point of the layer to be treated undergoes the heat treatment (or is brought to the maximum temperature), fora time advantageously within a range extending from 0.05 to 10 ms, in particular from 0.1 to 5 ms, or from 0.1 to 2 ms. In the case of a treatment using a laser line, this time is set both by the width of the laser line and by the speed of relative displacement between the substrate and the laser line. In the case of a treatment by means of a flash lamp, this time corresponds to the duration of the flash.

The speed of the relative motion between the substrate and the or each source of radiation (in particular the or each laser line) is advantageously at least 2 m/min or 4 m/min, in particular 5 m/min and even 6 m/min or 7 m/min, or else 8 m/min and even 9 m/min or 10 m/min. According to certain embodiments, in particular when the absorption of the radiation by the electrochromic stack is high or when the electrochromic stack may be deposited with high deposition rates, the speed of the relative motion between the substrate and the source of radiation (in particular the or each laser line or flash lamp) is at least 12 m/min or 15 m/min, in particular 20 m/min and even 25 or 30 m/min. In order to ensure a treatment which is as homogeneous as possible, the speed of the relative motion between the substrate and the or each source of radiation (in particular the or each laser line or flash lamp) varies during the treatment by at most 10% in relative terms, in particular 2% and even 1% relative to its nominal value.

Preferably, the or each source of radiation (in particular laser line or flash lamp) is stationary, and the substrate is moving, so that the speeds of relative motion will correspond to the run speed of the substrate.

This rapid heat treatment cleverly makes it possible to activate said transparent electrically conductive layers, i.e. to increase the conductivity while limiting the crystallinity. This limitation of the crystallization is demonstrated by a limitation of the size of the crystals formed during this annealing step since this size does not vary. For example, for ten samples of 10 cm² comprising an ITO layer, half of these samples are not heat-treated and half of them are heat-treated. It is observed that the mean value of the size of the crystals is 33.3 nm without heat treatment and 34.7 nm with laser treatment.

In a sixth step, an assembling step, referred to as a lamination step, is carried out in order to assemble the two glass panels.

Thus, advantageously, this ability to increase the electric conduction of the transparent electrically-conductive layers without increasing the size of the crystals and therefore the roughness makes it possible to improve the performance properties of the electrochromic glazing. Specifically, during the assembly of the glass panels 2, a stress appears in the electrolyte CI layer. This stress is the result of the roughness of the transparent conductive TCO1, TCO2 layers on said electrolyte layer, this electrolyte layer locally deforming/compressing so that said electrolyte CI layer has, locally, a variation in its thickness. This local thickness variation of the electrolyte CI layer over the whole of its surface leads to an electrochromic reaction of the electrochromic glazing which is not homogeneous and therefore to a drop in the performance properties.

Furthermore, with a decrease in the roughness following this rapid heat treatment, it then becomes possible to have the thinnest possible ionically conductive and electronically insulating electrolyte layer. Specifically, with a high roughness, it is necessary to provide an ionically conductive and electronically insulating electrolyte CI layer having a thickness which compensates for the thickness variation due to this roughness in order to retain satisfactory optical performance properties. Nevertheless, an increase in the thickness of the ionically conductive electrolyte CI layer leads to a reduction in the switching rate of the electrochromic glazing from the clear mode to the opaque mode and vice versa.

Thus, a lower roughness therefore makes it possible to compensate less for the thickness variation and therefore to have a thinner ionically conductive and electronically insulating electrolyte layer. The switching rate of the electrochromic glazing from the clear mode to the opaque mode and vice versa is therefore better.

Of course, the present invention is not limited to the example illustrated but can be varied and modified in various ways that will be apparent to a person skilled in the art.

1. A process for manufacturing an electrochromic glazing, said glazing comprising an electrochromic stack comprising:
a first transparent conductive layer,
a layer of an electrochromic material,
a layer of an ionically conductive electrolyte,
a counter electrode layer,
a second transparent conductive layer,
said process comprising:
providing a first glass panel and a second glass panel;
depositing the first transparent conductive layer on the first glass panel and the second transparent conductive layer on the second glass panel;
depositing the layer of an electrochromic material on the first conductive layer and the counter electrode layer on the second transparent conductive layer;
depositing the layer of an ionically conductive electrolyte on the layer of an electrochromic material or the counter electrode layer;
assembling the first and second glass panels to form a laminated glazing, and performing at least one heat treatment step that consists in heat treating at least one glass panel of the first and second glass panels provided with the respective first and second transparent conductive layers via a rapid heat treatment device before assembling the first and second glass panels.

2. The process as claimed in claim 1, wherein said heat treatment step is used to treat the first and second transparent conductive layer of each of the first and second glass panels.

3. The process as claimed in claim 1, wherein a heat treatment step is, in addition, used to treat the layer of an electrochromic material and/or the layer of a counter electrode.

4. The process as claimed in claim 1, wherein said step of heat treatment of said at least one transparent conductive layer is carried out after the deposition of the first transparent conductive layer on the first glass panel and/or of the second transparent conductive layer on the second glass panel.

5. The process as claimed in claim 1, wherein said heat treatment step used for treating the layer of an electrochromic material and/or the layer of a counter electrode is carried out after the deposition of the layer of the electrochromic material and/or of the counter electrode layer.

6. The process as claimed in claim 1, wherein said heat treatment step is carried out in order to simultaneously treat the layer of the electrochromic material and the first transparent conductive layer or in order to simultaneously treat the counter electrode layer and the second transparent conductive layer.

7. The process as claimed in claim 1, wherein the heat treatment device is placed facing a layer to be treated and wherein the heat treatment step is arranged to bring the layer to be treated to a temperature at least equal to 300° C. for a brief duration of less than 100 milliseconds.

8. The process as claimed in claim 1, wherein the heat treatment device is arranged to heat treat the layer to be treated for a brief duration of less than 100 milliseconds.

9. The process as claimed in claim 7, wherein the heat treatment device is a laser device emitting radiation that has a wavelength of between 300 and 2000 nm.

10. The process as claimed in claim 7, wherein the heat treatment device comprises at least one intense pulsed light lamp emitting radiation that has a wavelength of between 160 and 1000 nm.

11. The process as claimed in claim 10, wherein the heat treatment step is arranged so that each light pulse has a duration within a range extending from 0.05 to 20 milliseconds.
